(19) United States
(12) Patent Application Publication
(10) Pub. No.: US 2023/0045759 A1
(43) Pub. Date: Feb. 9, 2023

(54) 3D Calling Affordances

(71) Applicant: Meta Platforms Technologies, LLC, Menlo Park, CA (US)

(72) Inventors: Jing MA, Mill Creek, WA (US); Paul Armistead HOOVER, Bothell, WA (US); Oscar MURILLO, Redmond, WA (US); Fang-Yu YANG, Seattle, WA (US)

(21) Appl. No.: 17/393,830

(22) Filed: Aug. 4, 2021

(51) Int. Cl. H04N 7/14; H04N 5/89; G06T 19/00

(52) U.S. Cl. CPC H04N 7/141; G06T 19/006; H04N 5/89

(57) ABSTRACT

A 3D calling system can provide 3D calls in various modes according to transitions and can provide affordances (i.e., visual or auditory cues) to improve 3D call image capturing. The 3D calling system of a recipient in a 3D call can display a hologram (from images captured by an external capture device (ECD)) or avatar of a sending call participant in a variety of ways, such as by making them “world-locked,” “ECD-locked,” or “body-locked.” The selection of a 3D call mode can be based on factors such as whether an ECD is active, whether the ECD is in motion, and user selections. In various cases, the 3D calling system can trigger various affordances to improve the quality of the images captured by the sender’s ECD, such as a displayed virtual object and/or an auditory cue, either signaling to the user that a current ECD configuration is non-optimal and/or providing instructions for an improved ECD configuration.

### TECHNICAL FIELD

The present disclosure is directed to configuring display modes of a three-dimensional (3D) call and providing affordances for improving image capturing in a 3D call.

### BACKGROUND

Video conferencing has become a major way people connect. From work calls to virtual happy hours, webinars to online theater, people feel more connected when they can see other participants, bringing them closer to an in-person experience. However, video calls remain a pale imitation of face-to-face interactions. Understanding body language and context can be difficult with only a two-dimensional (“2D”) representation of a sender. Further, interpersonal interactions with video are severely limited as communication often relies on relational movements between participants.

Some artificial reality systems may provide the ability for users to engage in 3D calls, where a call participant can see a 3D representation of one or more other call participants. In such 3D calls, users can experience interactions that more closely mimic face-to-face interactions. For example, an artificial reality device can include a camera array that captures images of a sending call participant, reconstructs a hologram (3D model) representation of the sending call participant, encodes the hologram for delivery to an artificial reality device of a recipient call participant, which decodes and displays the hologram as a 3D model in the artificial reality environment of the recipient call participant. This may allow the recipient call participant to mover around the hologram, seeing it and interacting with it from different angles.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for setting context-based 3D calling modes.

FIG. 6 is a flow diagram illustrating a process used in some implementations of the present technology for enabling 3D call affordances in response to affordance triggers.

FIG. 7 is a conceptual diagram illustrating an example of a 3D call in a ECD in-use, live ECD-locked mode.

FIG. 8 is a conceptual diagram illustrating an example of a 3D call in a ECD in-use, live world-locked mode.

FIG. 9 is a conceptual diagram illustrating an example of a 3D call in a ECD not-in-use, avatar world-locked mode.

FIG. 10 is a conceptual diagram illustrating an example of a 3D call in a ECD not-in-use, avatar body-locked mode.

FIG. 11 is a conceptual diagram illustrating an example of a 3D call with a ECD placement affordance.

FIG. 12 is a conceptual diagram illustrating an example of a 3D call with a call mini-model affordance.

FIG. 13 is a conceptual diagram illustrating an example of a 3D call with a call capture boundary affordance.

FIG. 14 is a conceptual diagram illustrating an example of a 3D call with a camera blocked self-view affordance.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a 3D calling system that can provide 3D calls in various modes according to transitions and can provide affordances (i.e., visual or auditory cues to a user) to improve image capturing in the 3D call. In some cases, a 3D call can use an array of one or more cameras, incorporated in an external capture device (ECD), that is directed at a sending call participant. The live images of the sending call participant can be used to generate a hologram of the sending call participant for the 3D call. In other cases, the 3D calling system can generate an avatar representation of the sending call participant for use in the 3D call, which does not need images from an ECD to be generated.

The 3D calling system of a recipient in a 3D call can display the hologram or avatar of the sending call participant in a variety of ways, such as by making them “world-locked,” “ECD-locked,” or “body-locked.” World-locked virtual objects are positioned so as to appear stationary in the world, even when the call participant moves around in the artificial reality environment. ECD-locked virtual objects are positioned relative to the ECD, so as to appear at the same position relative to the ECD, despite the call participant’s movements. Body-locked virtual objects are positioned relative to the user of the artificial reality system, so as to appear at the same position relative to the user’s body, also despite the user’s movements.

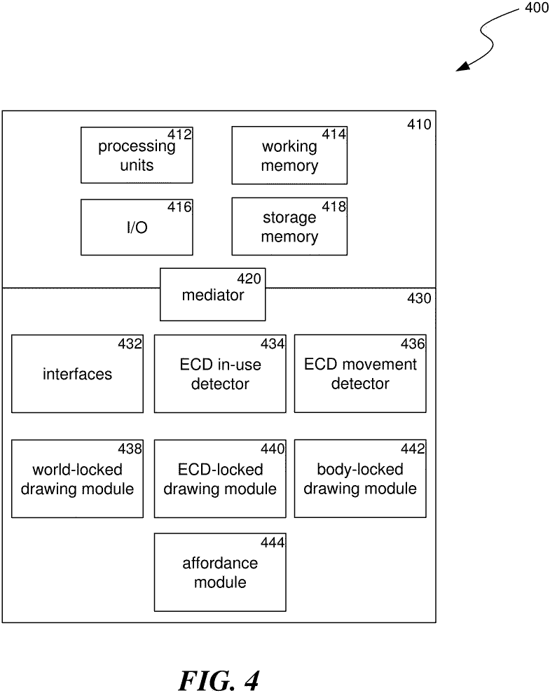

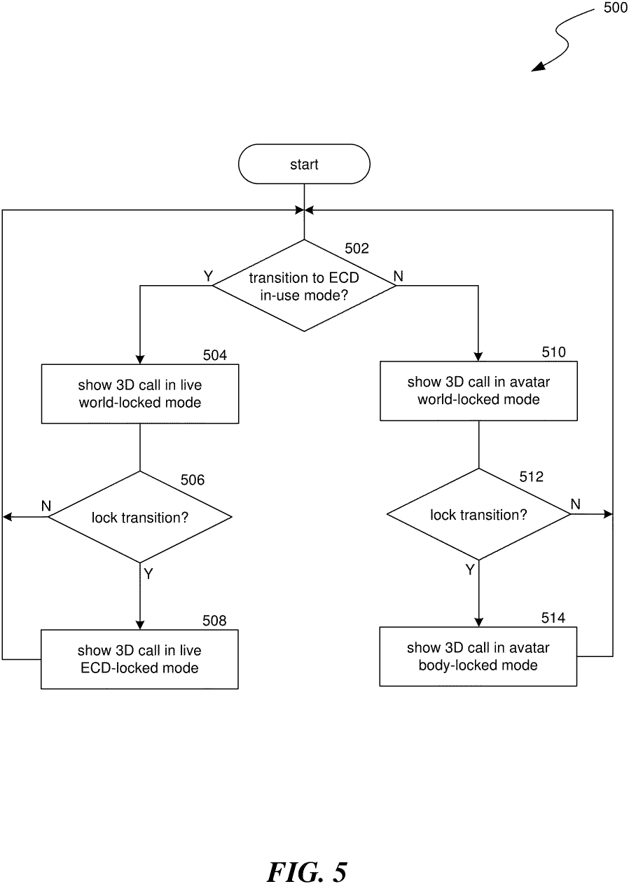

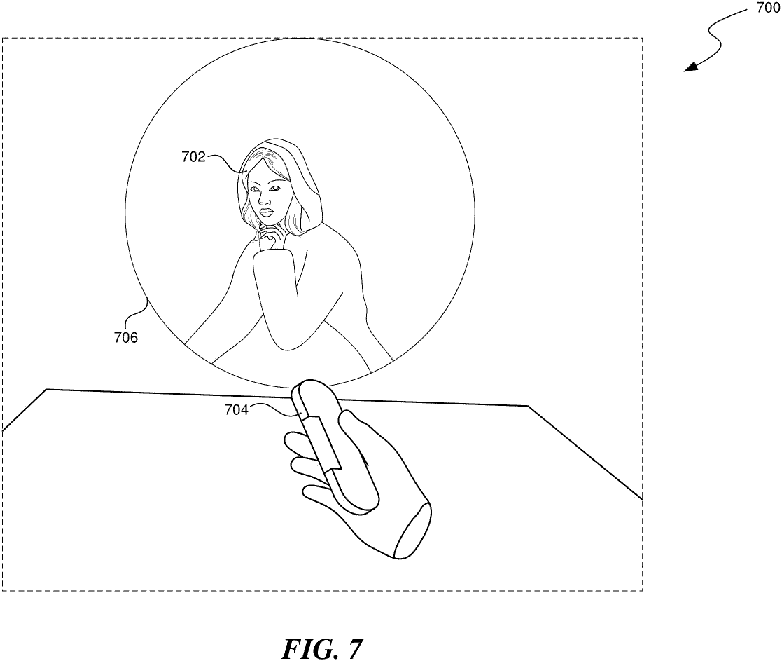

In various implementations, the selection of a 3D call mode can be based on a hierarchy where a live world-locked or live ECD-locked mode is under a first branch for when the ECD of the sending call participant is in use and an avatar world-locked and an avatar body-locked mode are under a second branch for when the ECD of the sending call participant is not in use. The selection of the first or second branch can be based on contextual factors such as whether the ECD of the sending call participant is powered on and/or the camera capture system of the ECD is active, whether this ECD is positioned to capture images of the sending call participant, whether images captured by this ECD are of sufficient quality to form a live hologram, and/or whether there are sufficient network and processing resources to conduct a live hologram call. In the first branch, the selection of the live world-locked mode or the live ECD-locked mode can be based on determined movements of a second ECD of the recipient call participant (e.g., whether this ECD has moved a threshold amount, how fast it’s been moved, where it’s been moved, etc.) In the second branch, the selection of the avatar world-locked mode or the avatar body-locked mode can be based on a user selection between the modes. Additional details on the selection of an 3D call mode are provided below in relation to FIG. 5, blocks 434-442 of FIG. 4, and FIGS. 7-10.

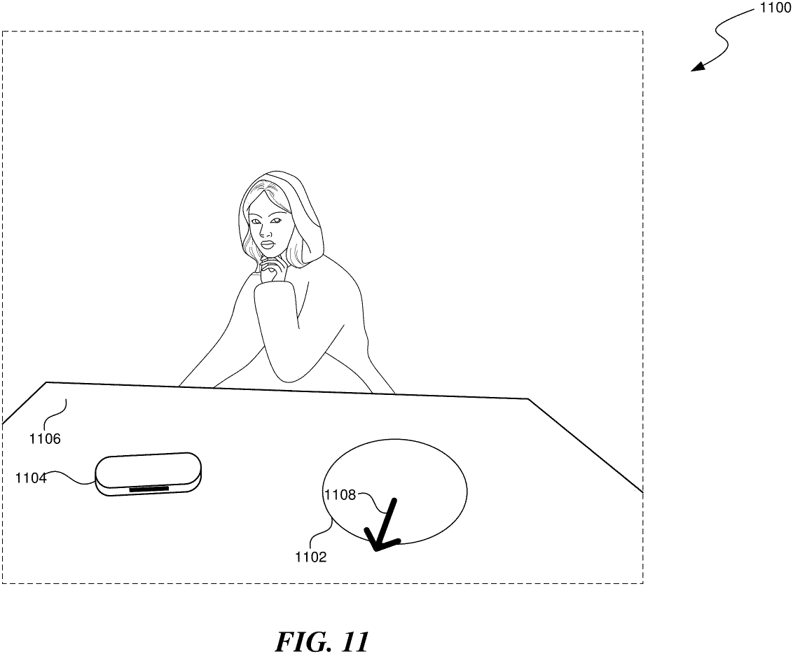

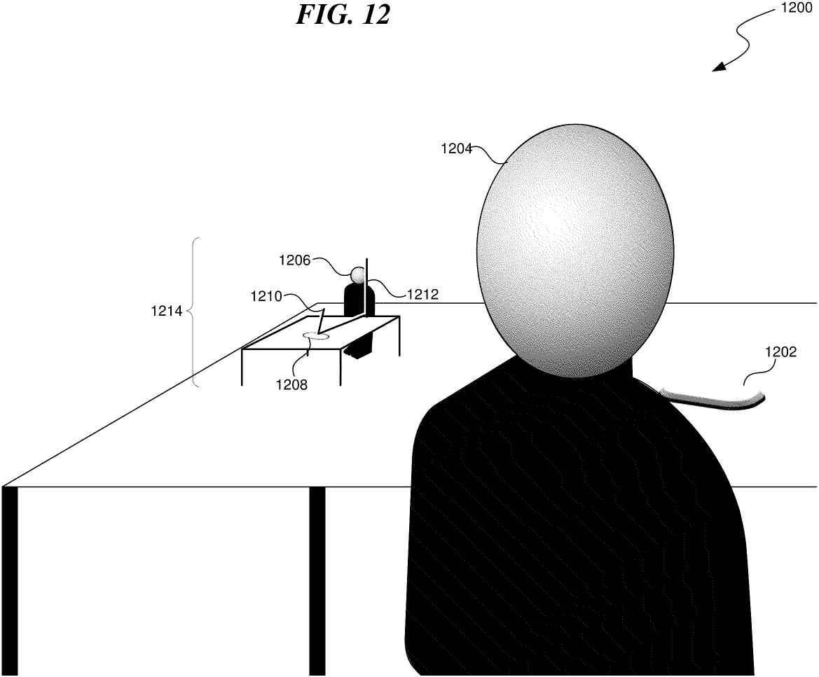

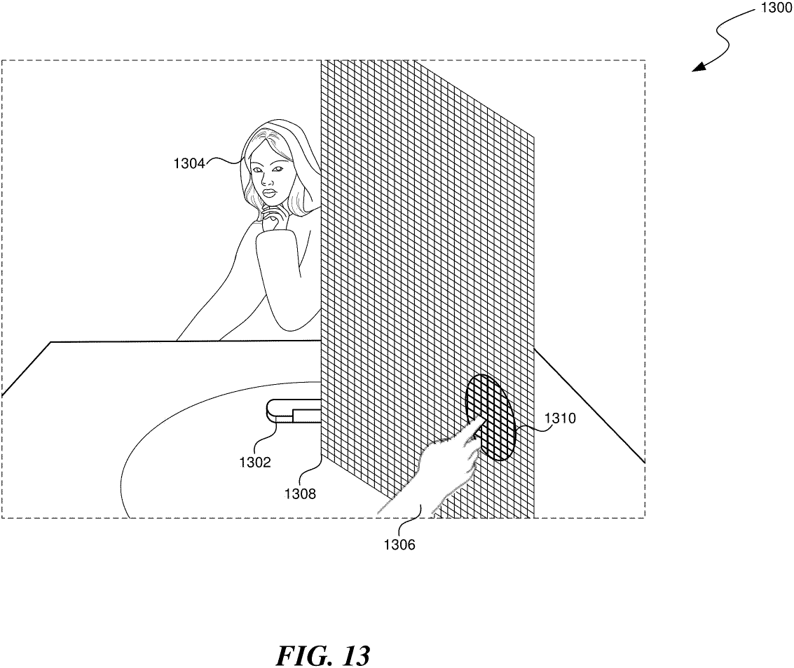

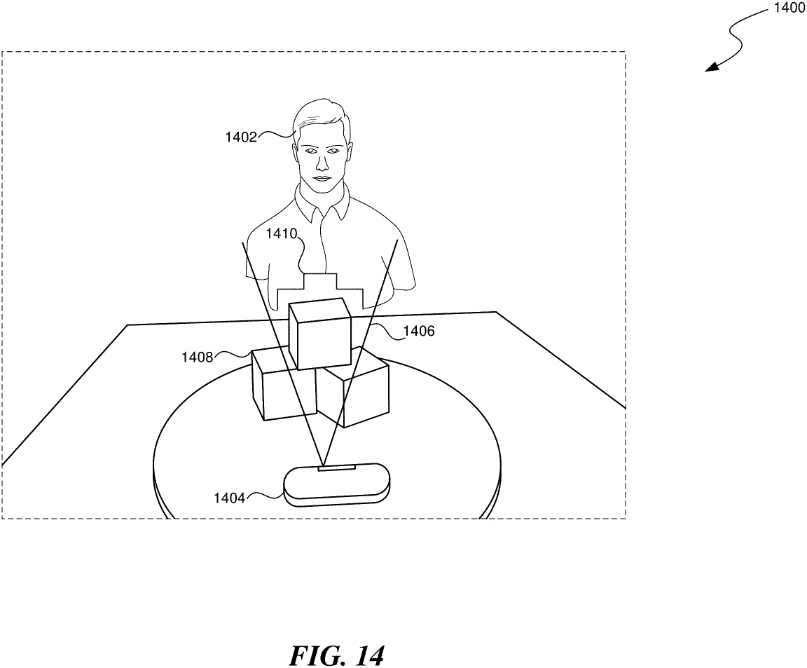

The 3D calling system can also trigger various affordances for the sending call participant to improve the quality of the images captured by the sending call participant’s ECD - e.g., by capturing more of the sending call participant or changing the relative orientation between the ECD and sending call participant to place the sending call participant in a more optimal range of cameras of the ECD. An “affordance,” as used herein, is a signal to the user such as a displayed virtual object and/or an auditory cue, either signaling to the user that a current ECD configuration is non-optimal and/or providing instructions for an improved ECD configuration. For example, affordances can be provided in the 3D call to instruct the user on how to position the ECD to capture quality images (see e.g., FIG. 11), to show the user in a mini-model how the ECD should be configured (see e.g., FIG. 12), to alert the user when part of the user moves outside the capture range of the ECD (see e.g., FIG. 13), or to warn the user when an object is occluding the ECD’s cameras from capturing images of the user (see e.g., FIG. 14).

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user’s visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user’s eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

While some existing artificial reality systems can provide 3D calling, they fail to account for changing contexts during the 3D call. For example, these existing artificial reality systems generally provide a 3D call as either world-locked or body-locked holograms, which either fail or lose substantial quality if circumstances change, such as the receiving call participant moving around the displayed hologram or the sending call participant moving outside the view of the capturing cameras. The 3D calling system and methods described herein are expected to overcome these deficiencies in existing artificial reality systems by switching between four 3D calling modes: live world-locked, live ECD-locked, avatar world-locked, and avatar body-locked, depending on context and user selections in the call. The 3D calling system and methods described herein are further expected to overcome these deficiencies by detecting affordance triggers (such as the beginning of a 3D call, a user moving outside the range of capture cameras, or an object occluding the capture cameras) and, in response, providing a corresponding affordance (such as an indication of where to place the ECD, where to move to be in range of the capture cameras, or how the capture cameras are being occluded). These triggers and corresponding mode switches and affordances provide improved image quality in the field of 3D calling.

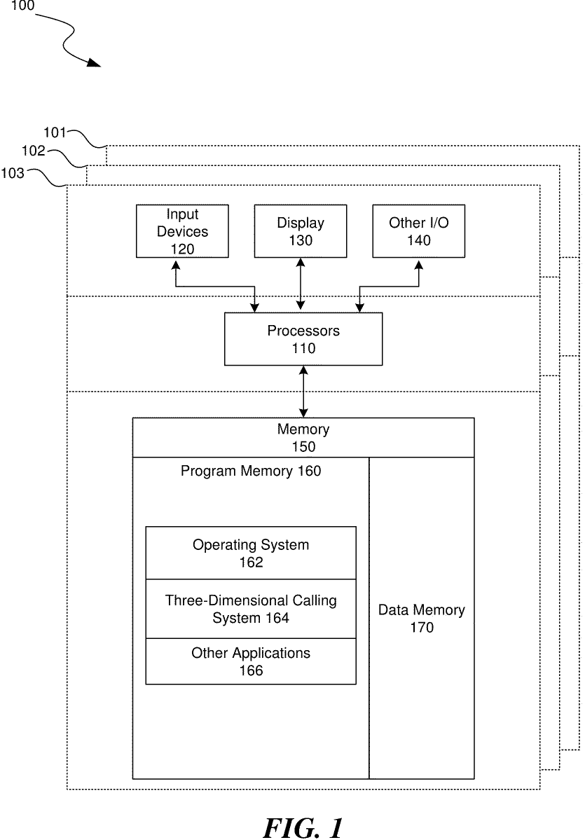

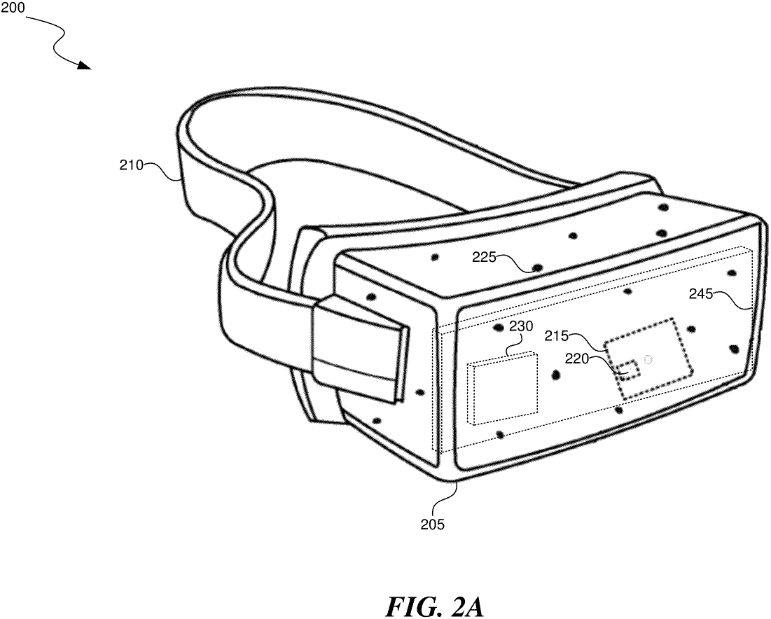

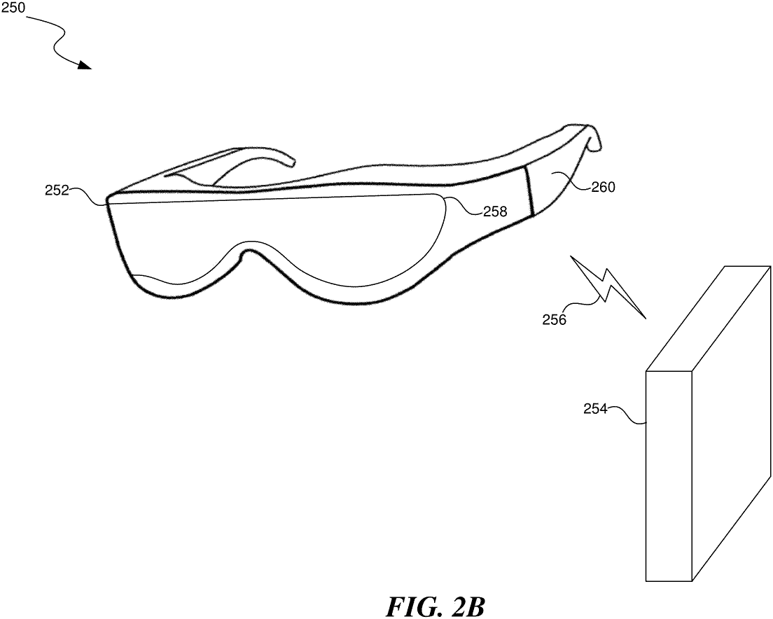

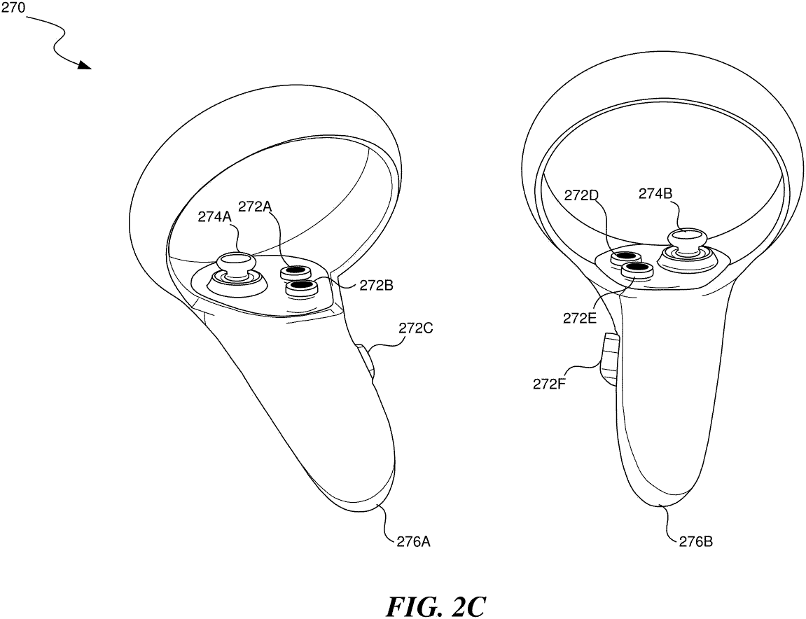

Several implementations are discussed below in more detail in reference to the figures. FIG. 1 is a block diagram illustrating an overview of devices on which some implementations of the disclosed technology can operate. The devices can comprise hardware components of a computing system 100 that can configure display modes of a 3D call and provide affordances for improving image capturing in a 3D call. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user’s location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, three-dimensional calling system 164, and other application programs 166. Memory 150 can also include data memory 170 that can include mappings of triggers 3D call mode changes, mappings of triggers to affordances, templates and data for displaying visual affordances and/or playing auditory affordances, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in a virtual environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. In some implementations, the ECD discussed herein can be the core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user’s eye. Image data can be transmitted from the core processing component 254 via link 256 to HMD 252. Controllers in the HMD 252 can convert the image data into light pulses from the projectors, which can be transmitted via the optical elements as output light to the user’s eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user’s hands to determine gestures and other hand and body motions. As another example, one or more light sources can illuminate either or both of the user’s eyes and the HMD 200 or 250 can use eye-facing cameras to capture a reflection of this light to determine eye position (e.g., based on set of reflections around the user’s cornea), modeling the user’s eye and determining a gaze direction.

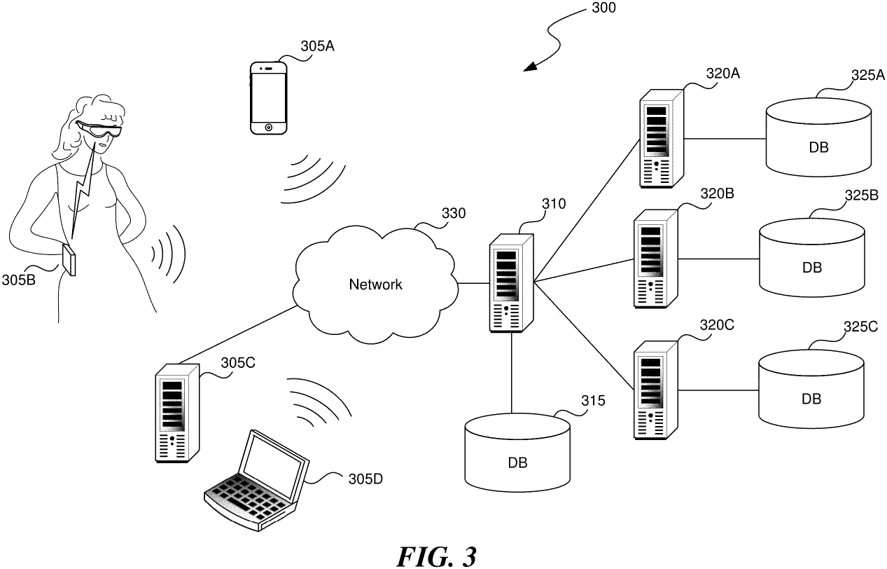

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for setting a mode controlling how a 3D call is presented by an artificial reality system and providing affordances for improving ECD capture of images. Specialized components 430 can include ECD in-use detector 434, ECD movement detector 436, world-locked drawing module 438, ECD-locked drawing module 440, body-locked drawing module 442, affordance module 444, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

ECD in-use detector 434 can determine whether the ECD of a sending call participant is being used. When the ECD of a sending call participant is being used, a representation of the sending call participant can be a live hologram, whereas when the ECD of a sending call participant is now being used, a representation of the sending call participant can be an avatar. The ECD in-use detector 434 can make this determination based on whether the ECD of the sending call participant is powered on and/or the camera capture system of the ECD is active, whether this ECD is positioned to capture images of the sending call participant, whether images captured by this ECD are of sufficient quality to form a live hologram, and/or whether there are sufficient network and processing resources to conduct a live hologram call. Additional details on selecting an ECD in-use mode are provided below in relation to block 502 of FIG. 5.

ECD movement detector 436 can determine whether movement characteristics of an ECD of a recipient call participant triggers a lock transition. The ECD movement detector 436 can monitor movement characteristics such as whether the ECD has moved a threshold amount, how fast it’s been moved, and/or where it’s been moved. Depending on these movement characteristics, a representation of the sending call participant (either a hologram or an avatar) can be positioned relative to a geographical point (i.e., be world-locked) or be positioned relative to the ECD (i.e., be ECD-locked). Additional details on determining the ECD movement characteristics are provided below in relation to block 506 of FIG. 5.

World-locked drawing module 438 can draw an avatar or hologram representation of a sending call participant relative to a tracked geographical point even as the artificial reality device moves. Thus, the world-locked drawing module 438 can use photo tracking and other means of determining the relative position of the artificial reality device to the geographical position and, as the artificial reality device moves, can repeatedly update the avatar or hologram representation to appear as if it’s staying in the same location. Additional details on drawing a hologram or avatar in a world-locked position are provided below in relation to blocks 504 and 510 of FIG. 5.

ECD-locked drawing module 440 can draw an avatar or hologram representation of a sending call participant relative to an ECD of a recipient call participant. Thus, the ECD-locked drawing module 440 can determined the relative position of the artificial reality device to the ECD and, as the artificial reality device and/or ECD moves, can repeatedly update the avatar or hologram representation to appear as if it’s staying in the position relative to the ECD. Additional details on drawing a hologram or avatar in an ECD-locked position are provided below in relation to block 508 of FIG. 5.

Body-locked drawing module 442 can draw an avatar or hologram representation of a sending call participant relative to a body part or the artificial reality device of a recipient call participant. In some cases, the body-locked drawing module 442 can determined the relative position of the artificial reality device to the body part and, as the artificial reality device and/or body part moves, can repeatedly update the avatar or hologram representation to appear as if it’s staying in the position relative to the body part. In other cases, the body-locked drawing module 442 can display the hologram or avatar for the sending 3D call participant so as to appear consistently placed relative to the recipient 3D call participant by displaying the avatar at a consistent location in a display of the recipient 3D call participant, without updating its location according to how the artificial reality device is moved. Additional details on drawing a hologram or avatar in a body-locked position are provided below in relation to block 514 of FIG. 5.

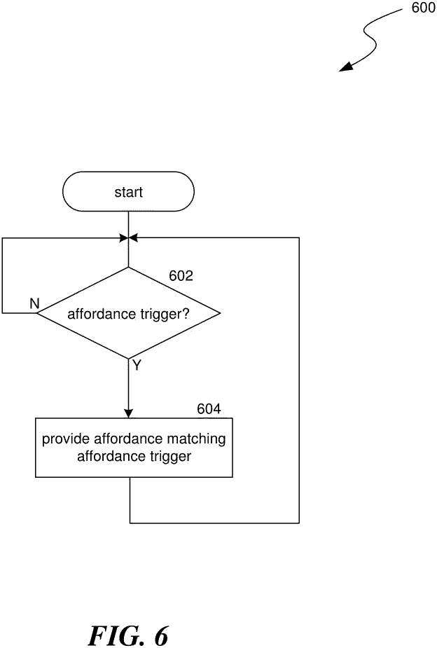

Affordance module 444 can display various affordances to help position the ECD and/or position the sending call participant relative to the ECD. In one case, the affordance can be an indication of where to place the ECD. In another case, the affordance can be a mini-model depicting miniature representations of both the sending call participant and the ECD. In a further case, the affordance can display a virtual boundary illustrating a portion of a capture range of the ECD. In yet a further case, the affordance can display a self-view of the sending call participant with a portion of the sending 3D call participant that is blocked from view of the ECD excluded from the self-view. In some cases, affordances can be auditory, such as a chime or recording. Additional details on providing affordances for ECD placement and adjustments are provided below in relation to FIGS. 6 and 11-14.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for setting context-based 3D calling modes. Process 500 can be initiated when a 3D call starts, e.g., on an artificial reality device.

At block 502, process 500 can determine whether an event for transitioning to the ECD in-use mode is detected. In various implementations, an event for transitioning to the ECD in-use mode can include one or more of: the ECD of the sending call participant being powered on and/or the camera capture system of the ECD is active to take the yes branch to block 504; this ECD being powered off to take the no branch to block 510; process 500 determining that images captured by this ECD are above a quality threshold to take the yes branch to block 504; process 500 determining that images captured by this ECD are below the quality threshold to take the no branch to block 510; process 500 determining that images captured by this ECD depict at least a face of the sending call participant to take the yes branch to block 504; process 500 determining that images captured by the ECD do not include at least the face of the sending call participant to take the no branch to block 510; process 500 determining that available computing resources (e.g., memory, processor availability, network bandwidth, etc.) are above a resource threshold level to take the yes branch to block 504; or process 500 determining that at least one of the computing resources are below the resource threshold to take the no branch to block 510. In some implementations, combinations of these events have to exist to take the yes branch to block 504, such as the camera capture system of the ECD of the sending call participant being active, the quality being above the quality threshold, the images depicting the sending call participant, and there being sufficient computing resources; otherwise process 500 can take the no branch to block 510.

At block 504, process 500 can show the 3D call in a live world-locked mode. This can include initially positioning the hologram of the sending call participant in a world-locked location, which may be selected relative to the initial placement of the ECD, but will stay at that location if the ECD is moved while in the live world-locked mode. In other cases, the location of the hologram can be selected based on other real and/or virtual objects in the room. For example, this world-locked location can be placed above a detected local horizontal flat surface (such as above a table or above an area of the floor) a specified distance from the position of the recipient call participant, at an area where the recipient call participant is looking when the live world-locked mode was entered, etc. In some implementations, the location for the hologram of the sending call participant can be selected by the recipient call participant, either by directing an input to that location or by moving a current view of the hologram (e.g., with a grab and drag gesture) to the world-locked location that the recipient call participant desires. In some cases when an ECD in-use mode is entered, an affordance can be shown to the sending participant to help the user reposition herself and/or the ECD to better capture images of the sending participant (see e.g., FIGS. 11-14).

At block 506, process 500 can determine whether an event is detected for transitioning how the 3D call is locked. In various implementations, the lock transition can be determined to occur when one or a combination of various movements of an ECD of the recipient call participant are above threshold levels. In cases where the ECD of the recipient call participant is not in use, process 500 can take the no branch from block 506. The various movements of the recipient call participant’s ECD can include one or more of: a distance of movement, a speed of movement, an angle of rotation, or whether the movement causes the ECD of the recipient call participant to approach a boundary (e.g., a boundary of a room or near a doorway or other portal). For example, the lock transition can occur when the ECD of the recipient call participant is moved a threshold distance such as 1, 2, or 3 meters; the lock transition can occur when this ECD is moved at a speed above .1, .2. or .4 meters/second; the lock transition can occur when this ECD is rotated at least 10, 30, or 90 degrees; or various areas can be identified as a boundary of a room, the artificial reality device can track where this ECD is within the room, and the lock transition can occur when this ECD is moved over, or within a threshold distance (e.g., .5, 1, or 2 meters) of, the boundary. In some implementations, the lock transition can occur when a specified combination of these events occurs (e.g., both the distance and angle events). Different threshold levels can be set for such a combination. For example, while movement of the ECD by two meters alone can trigger the lock transition, movement of the ECD by one meter and a rotation by 45 degrees may also trigger the lock transition.

At block 508, process 500 can show the 3D call in a live ECD-locked mode. The ECD-locked mode can anchor the hologram of the sending call participant to the ECD, such that as the ECD is moved the hologram of the sending call participant is moved (from the viewpoint of the recipient call participant) a corresponding amount.

At block 510, following process 500 determining at block 502 not to be in ECD in-use mode (i.e., being in an ECD not-in-use mode), process 500 can show the 3D call in an avatar world-locked mode. Because the ECD used to create a hologram of the sending participant is not in use, an avatar representing the sending participant can be displayed instead. The avatar can be a generic avatar, an avatar automatically created to resemble the sending participant, or an avatar with features selected by the sending participant, the recipient participant, or automatically (e.g., based on identified interests, characteristics, etc., of the sending participant). The avatar world-locked mode can include initially positioning the avatar representation the sending call participant in a world-locked location, which may be selected relative to the initial position of the recipient participant, but will stay at that location if the recipient participant moves while in the avatar world-locked mode. In other cases, the location of the avatar can be selected based on other real and/or virtual objects in the room. For example, this world-locked location can be placed above a detected local horizontal flat surface (such as above a table or above an area of the floor) a specified distance from the position of the recipient call participant, at an area where the recipient call participant is looking when the avatar world-locked mode was entered, etc. In some implementations, the location for the avatar of the sending participant can be selected by the recipient participant, either by directing an input to that location or by moving a current view of the avatar (e.g., with a grab and drag gesture) to the world-locked location that the recipient participant desires.

In some implementations, when system is not in the ECD in-use mode, this can be signaled to the sending participant, which may include a reason and/or an affordance for correcting the reason the ECD is not in use. For example, if the sending participant is out of view, or partially out of view of the cameras of the ECD, this can be signaled to the sending participant with an audio chime or recording affordance and/or through a visual affordance such as a grid virtual object showing where the cameras can capture (see e.g., FIG. 13), how objects are blocking the cameras of the ECD (see e.g., FIG. 14), a mini-model of the sending participant in relation to the ECD and how the cameras are capturing the sending participant (see e.g., FIG. 12), with an indication that images captured by the ECD are not of sufficient quality to generate a hologram of the sending participant, that available computing resources for creating or sending hologram data are insufficient, etc. In some cases where the placement of the ECD is the problem, an affordance to help the user reposition herself and/or the ECD can be provided (see e.g., FIG. 11).

At block 512, process 500 can determine whether an event is detected for transitioning how the 3D call is locked. The lock transition event, at block 512, can include identifying a manual, recipient selection for switching between the avatar representation of the sending participant being world-locked to being body-locked. Such a recipient selection can be signaled with a voice command, activating a control (e.g., button or menu item virtual object) in an artificial reality environment, performing a gesture mapped to the switch, etc.

At block 514, process 500 can show the 3D call in an avatar body-locked mode. The avatar being body locked can include causing the representation of the avatar to stay at a position relative to the body of the recipient participant, even as the recipient participant moves.

Following blocks 508 or 514, process 500 can return to block 502 to update whether the 3D call should stay in ECD in-use mode. These loops can continue while the 3D call is ongoing. Process 500 can end when the 3D call ends.

FIG. 6 is a flow diagram illustrating a process 600 used in some implementations of the present technology for enabling 3D call affordances in response to affordance triggers. Process 600 can be initiated when a 3D call starts, e.g., on an artificial reality device.

At block 602, process 600 can determine whether an affordance trigger has occurred. In various implementations, various events can be recognized as an affordance trigger, such as one or more of: entering an ECD in-use mode; identifying that relative positioning between a sending call participant and an ECD is preventing cameras of the ECD from capturing complete images of the sending call participant; determining that an object is occluding one or more cameras of the ECD, preventing it from capturing complete images of the sending call participant; determining that computing resources are below threshold levels; etc.

At block 604, process 600 can provide an affordance mapped to the affordance trigger determined to have occurred at block 602. The affordance trigger of entering an ECD in-use mode can be mapped to an affordance including providing an indication, in an artificial reality environment, of where the sending participant should place her ECD, e.g., with an overlay (see e.g., FIG. 11) or with a mini-model (see e.g., FIG. 12). The affordance trigger of identifying that relative positioning between a sending call participant and an ECD is preventing cameras of the ECD from capturing complete images of the sending call participant can be mapped to an affordance including providing an indication, in an artificial reality environment, of how the sending participant should reposition her ECD or herself, e.g., with an overlay (see e.g., FIG. 11), with a mini-model (see e.g., FIG. 12), or a virtual object showing where the sending participant is outside the capture range of the ECD (see e.g., FIG. 13). The affordance trigger of determining that an object is occluding one or more cameras of the ECD, preventing it from capturing complete images of the sending call participant can be mapped to an affordance including showing, in an artificial reality environment, how the object is blocking the full capture of the sending participant (see e.g., FIG. 14). The affordance trigger of determining that computing resources are below threshold levels can be mapped to an affordance including providing a chime, recording, or other auditory notice or visual notice of the limed resources. In each instance such affordances can further include textual, auditory, or graphical reasons for the affordance trigger and/or instruction on how to improve the 3D call setup.

Following block 604, process 600 can return to block 602 to update whether an affordance trigger has occurred. This loop can continue while the 3D call is ongoing. Process 600 can end when the 3D call ends.

FIG. 7 is a conceptual diagram illustrating an example 700 of a 3D call in a ECD in-use, live ECD-locked mode. Example 700 includes a hologram 702, of a sending 3D call participant because this is a live mode, which is positioned relative to an ECD 704. In example 700, an effect of a circle 706, around the hologram 702 and linked to the ECD 704, is provided to indicate the 3D call is in ECD-locked mode. In the ECD-locked mode shown in example 700, as the user moves the ECD 704, the hologram 702 is moved so as to appear consistently placed relative to the ECD 704. Thus, the location of the ECD 704 is tracked and the view of the hologram 702 is updated to appear as if it’s staying relative to the ECD 704.

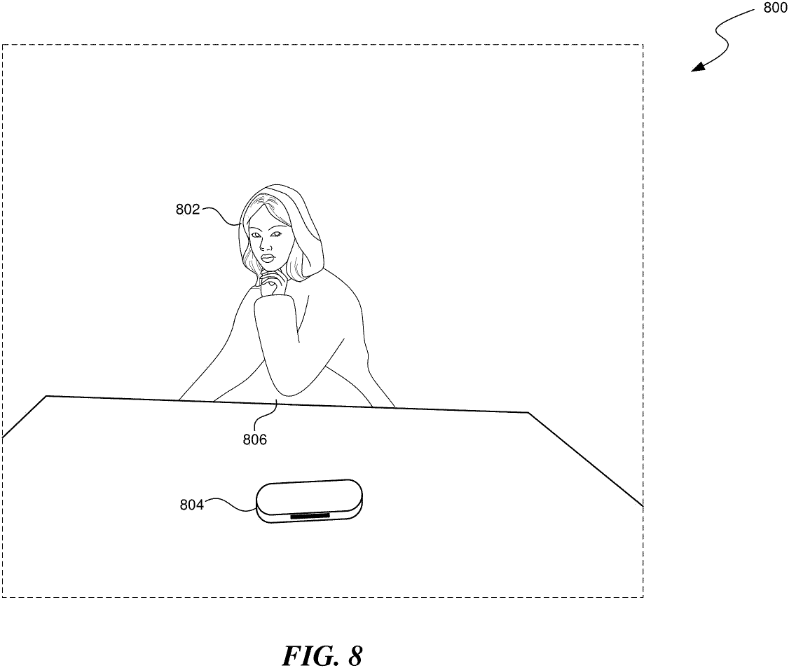

FIG. 8 is a conceptual diagram illustrating an example 800 of a 3D call in a ECD in-use, live world-locked mode. Example 800 includes a hologram 802, of a sending 3D call participant because this is a live mode, which is in a world-locked position, relative to point 806. Example 800 also includes an ECD 804 capturing images of another call participant (not shown), to create and send hologram data to the user represented by hologram 802. In the world-locked mode shown in example 800, as the recipient call participant moves about (e.g., while wearing an artificial reality device that is displaying the hologram 802) the point 806 is tracked and the view of the hologram 802 is updated to appear as if it’s staying in the same spot, despite the movements of the artificial reality device that’s displaying it.

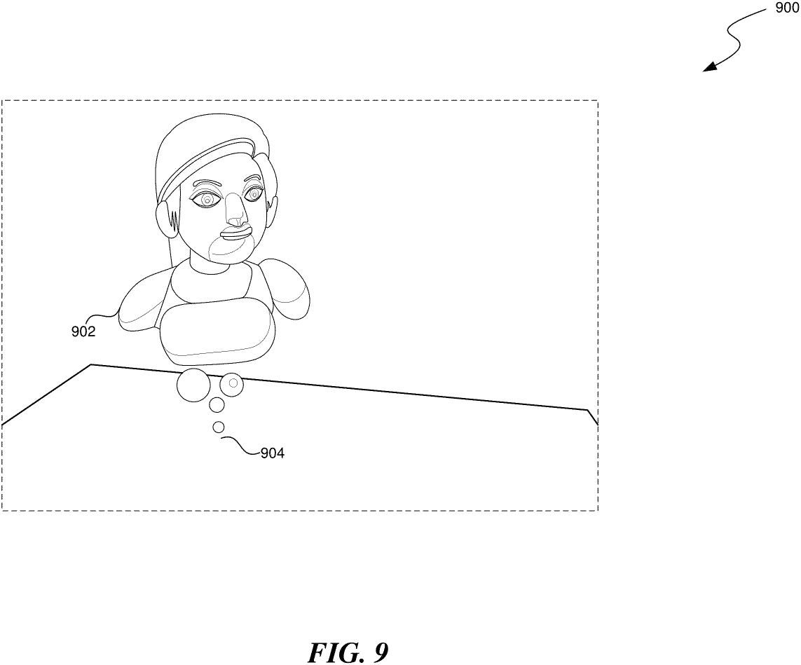

FIG. 9 is a conceptual diagram illustrating an example 900 of a 3D call in a ECD not-in-use, avatar world-locked mode. Example 900 includes an avatar representation 902, of a sending 3D call participant, because this is an avatar mode. The avatar representation 902 is in a world-locked position, relative to point 904. In the world-locked mode shown in example 900, as a recipient call participant moves about (e.g., while wearing an artificial reality device that is displaying the avatar representation 902) the point 904 is tracked and the view of the avatar representation 902 is updated to appear as if it’s staying in the same spot, despite the movements of the artificial reality device that’s displaying it.

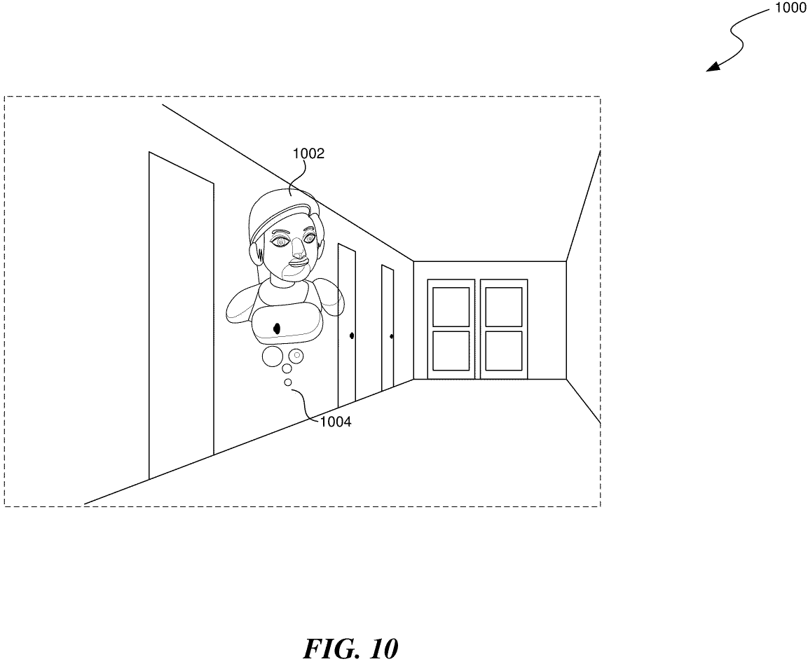

FIG. 10 is a conceptual diagram illustrating an example 1000 of a 3D call in a ECD not-in-use, avatar body-locked mode. Example 1000 includes an avatar representation 1002, of a sending 3D call participant, because this is an avatar mode. The avatar representation 1002 is in a body-locked position, relative to the position 1004, defined by a location of the recipient call participant. In various implementations, position 1004 can be a point on the recipient participant’s body (not shown in example 1000) or a point relative to the position of the artificial reality device worn by the recipient call participant. In the body-locked mode shown in example 1000, as a recipient call participant moves about, the point 1004 changes relative to the world, causing the view of the avatar representation 1002 to change accordingly. In some implementations, this can be done by tracking the point 1004 and updating the view of the avatar representation 1002, while in other cases the artificial reality device simply provides the view of the avatar representation 1002, without locking it to a particular point in the world, thus causing the view of the avatar representation 1002 to remain relative to the position of the artificial reality device as it is moved.

FIG. 11 is a conceptual diagram illustrating an example 1100 of a 3D call with a ECD placement affordance. In example 1100, a 3D call has begun in which the ECD 1104 is capturing images of a sending participant (not shown). The artificial reality system has identified a flat surface 1106 in front of the sending participant in an area at which the ECD would be in an optimal range and angle for capturing the images of the sending participant. The artificial reality system has displayed a first visual affordance as the circle virtual object 1102, indicating an area on the surface 1106 in which the ECD 1104 should be placed. The artificial reality system has also displayed a second visual affordance as the arrow virtual object 1108, indicating an orientation for the ECD 1104 relative to the sending participant.

FIG. 12 is a conceptual diagram illustrating an example 1200 of a 3D call with a call mini-model affordance. In example 1200, an ECD 1202 is capturing images of a sending participant 1204 as part of a 3D call. An artificial reality system has displayed a visual affordance as mini-model 1214, including a representation 1206 of the participant 1204, a representation 1208 of the ECD 1202, an indication 1210 of the capture range of the ECD 1202, and an illustration 1212 indicating parts of the participant 1204 that are outside the capture range of the ECD 1202. This live representation in the mini-model 1214 can allow the participant 1204 to reposition herself and/or the ECD 1202 so she is completely in the range of the ECD’s camera array. In various implementations, the mini-model 1214 can be shown throughout the 3D call, only when the artificial reality system detects that at least part of the sending participant is outside the ECD’s camera range, or only when the artificial reality system detects that a particular part (e.g., the head) of the sending participant is outside the ECD’s camera range.

FIG. 13 is a conceptual diagram illustrating an example 1300 of a 3D call with a call capture boundary affordance. Example 1300 includes an ECD 1302 capturing images of a sending participant, whose arm is shown at 1306, while in a 3D call with a recipient participant represented by hologram 1304. ECD 1302 has a capture range and when a portion of the sending participant goes outside that capture range, a visual affordance is displayed as a boundary virtual object, illustrating an edge of the capture range and where the sending participant is outside it. In example 1300, a part of the sending participants' arm 1306 has gone outside the ECD 1302's capture range. In response, the artificial reality system has displayed the boundary 1308 and indication 1310 showing where the sending participants' arm 1306 has passed outside the ECD 1302's capture range.

FIG. 14 is a conceptual diagram illustrating an example 1400 of a 3D call with a camera blocked self-view affordance. In example 1400, a hologram 1402 is displayed showing a self-view of a sending call participant as captured by an ECD 1404. The ECD 1404 has an image capture range shown by lines, such as line 1406. Part of the sending participant is blocked by objects 1408, placed in the capture range in front of the ECD 1404. Due to this, the self-view hologram 1402 is missing portions 1410, allowing the sending participant to understand how the objects 1408 are blocking the cameras of the ECD 1404. In some cases, when a call is in progress and a new object appears that is blocking part of the ECD’s cameras (e.g., the sending participant puts her coffee cup down in front of the ECD) either or both the self-view hologram can be displayed and/or an auditory indication can be provided that the cameras are partially blocked.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for setting a mode controlling how a 3D call is presented by an artificial reality system, the method comprising:
determining whether a first external capture device (ECD) of a sending 3D call participant is in-use, if so, entering an ECD in-use mode, and if not entering an ECD not-in-use mode;
when in the ECD in-use mode, determining, based on determined movements of a second ECD of a recipient 3D call participant, whether a first lock transition has occurred,
if so, entering a live world-locked mode in which a hologram representing the sending 3D call participant is displayed so as to appear consistently placed relative to a geographical location, and
if not, entering a live ECD-locked mode in which the hologram representing the sending 3D call participant is displayed so as to appear consistently placed relative to the second ECD; and
when in the ECD not-in-use mode, determining whether a second lock transition, based on a user world-locked selection, has occurred,
if so, entering an avatar world-locked mode in which an avatar for the sending 3D call participant is displayed so as to appear consistently placed relative to a geographical location, and
if not, entering an avatar body-locked mode in which the avatar for the sending 3D call participant is displayed so as to appear consistently placed relative to the recipient 3D call participant.

2. The method of claim 1,
wherein the determining whether the first ECD is in-use comprises determining that the first ECD is in-use; and
wherein determining that the first ECD is in-use comprises one or more of:
determining that a camera capture system of the first ECD is active;
determining that images captured by the first ECD are above a quality threshold;
determining that images captured by the first ECD depict at least a face of the sending 3D call participant;
determining that available computing resources are above a resource threshold level; or
any combination thereof.

3. The method of claim 1,
wherein determining whether the first ECD is in-use comprises determining that the first ECD is in-use; and
wherein determining whether the first lock transition has occurred comprises one or more of:
determining that the second ECD has moved a threshold distance;
determining that the second ECD has moved above a threshold speed;
determining that the second ECD has rotated at least a threshold amount;
determining that the second ECD has moved over or within a threshold distance of an area identified as a boundary of a room; or
any combination thereof.

4. The method of claim 1,
wherein determining whether the first ECD is in-use comprises determining that the first ECD is in-use;
wherein determining whether the first lock transition has occurred comprises determining that the first lock transition has occurred; and
wherein the geographical location is determined based on a detected horizontal flat surface that is a specified distance from a position of the recipient 3D call participant.

5. The method of claim 1,
wherein determining whether the first ECD is in-use comprises determining that the first ECD is in-use;
wherein determining whether the first lock transition has occurred comprises determining that the first lock transition has not occurred; and
wherein the hologram representing the sending 3D call participant is displayed so as to appear consistently placed relative to the second ECD by tracking a position of the second ECD and repeatedly updating a displayed position of the hologram representing the sending 3D call participant according to the tracked position.

6. The method of claim 1,
wherein determining whether the first ECD is in-use comprises determining that the first ECD is not in-use;
wherein determining whether the second lock transition has occurred comprises determining that the second lock transition has not occurred; and
wherein the avatar for the sending 3D call participant is displayed so as to appear consistently placed relative to the recipient 3D call participant by displaying the avatar at a consistent location in a display of the recipient 3D call participant.

7. The method of claim 1,
wherein the determining whether the first ECD is in-use comprises determining that the first ECD is in-use; and
wherein the method further comprises, in response to determining that the first ECD is in-use, causing display of an affordance to the sending 3D call participant by displaying a virtual object signaling where to place the first ECD.

8. The method of claim 1,
wherein the determining whether the first ECD is in-use comprises determining that the first ECD is in-use; and
wherein the method further comprises:
causing display of an affordance to the sending 3D call participant by displaying a mini-model depicting miniature representations of both the sending 3D call participant and the first ECD.

9. The method of claim 1,
wherein the determining whether the first ECD is in-use comprises determining that the first ECD is in-use; and
wherein the method further comprises determining that at least a portion of the sending 3D call participant is outside a capture range of the first ECD and, in response, causing display of an affordance to the sending 3D call participant by displaying a virtual boundary illustrating a portion of the capture range of the first ECD.

10. The method of claim 1,
wherein the determining whether the first ECD is in-use comprises determining that the first ECD is in-use; and
wherein the method further comprises determining that at least a portion of the sending 3D call participant is blocked from view of the first ECD and, in response, causing display of an affordance to the sending 3D call participant by displaying a self-view of the sending 3D call participant with the blocked portion of the sending 3D call participant excluded.

11. A computer-readable storage medium storing instructions that, when executed by a computing system, cause the computing system to perform a process for setting a mode controlling how a 3D call is presented by an artificial reality system, the process comprising:
determining whether a first external capture device (ECD) of a sending 3D call participant is in-use, if so, entering an ECD in-use mode, and if not entering an ECD not-in-use mode;
when in the ECD in-use mode, determining, based on determined movements of a second ECD of a recipient 3D call participant, whether a first lock transition has occurred,
if so, displaying a hologram in a world-locked mode, and
if not, displaying the hologram in ECD-locked mode; and
when in the ECD not-in-use mode, determining whether a second lock transition, based on a user world-locked selection, has occurred,
if so, displaying an avatar in the world-locked mode, and
if not, displaying the avatar a body-locked mode.

12. The computer-readable storage medium of claim 11,
wherein the determining whether the first ECD is in-use comprises determining that the first ECD is in-use; and
wherein determining that the first ECD is in-use comprises one or more of:
determining that a camera capture system of the first ECD is active;
determining that images captured by the first ECD are above a quality threshold;
determining that images captured by the first ECD depict at least a face of the sending 3D call participant;
determining that available computing resources are above a resource threshold level; or
any combination thereof.

13. The computer-readable storage medium of claim 11,
wherein determining whether the first ECD is in-use comprises determining that the first ECD is in-use; and
wherein determining whether the first lock transition has occurred comprises one or more of:
determining that the second ECD has moved a threshold distance;
determining that the second ECD has moved above a threshold speed;
determining that the second ECD has rotated at least a threshold amount;
determining that the second ECD has moved over or within a threshold distance of an area identified as a boundary of a room; or
any combination thereof.

14. The computer-readable storage medium of claim 11,
wherein determining whether the first ECD is in-use comprises determining that the first ECD is in-use;
wherein determining whether the first lock transition has occurred comprises determining that the first lock transition has occurred; and
wherein a geographical location for the world-locked mode is determined based on a detected horizontal flat surface that is a specified distance from a position of the recipient 3D call participant.

15. The computer-readable storage medium of claim 11,
wherein determining whether the first ECD is in-use comprises determining that the first ECD is in-use;
wherein determining whether the first lock transition has occurred comprises determining that the first lock transition has not occurred; and
wherein the hologram represents the sending 3D call participant and is displayed so as to appear consistently placed relative to the second ECD by tracking a position of the second ECD and repeatedly updating a displayed position of the hologram representing the sending 3D call participant according to the tracked position.

16. The computer-readable storage medium of claim 11,
wherein determining whether the first ECD is in-use comprises determining that the first ECD is not in-use;
wherein determining whether the second lock transition has occurred comprises determining that the second lock transition has not occurred; and
wherein the avatar is for the sending 3D call participant and is displayed so as to appear consistently placed relative to the recipient 3D call participant by tracking a position of a part of the body of the recipient 3D call participant and repeatedly updating a displayed position of the avatar according to the tracked position.

17. A computing system for setting a mode controlling how a 3D call is presented by an artificial reality system, the computing system comprising:
one or more processors; and
one or more memories storing instructions that, when executed by the one or more processors, cause the computing system to perform a process comprising:
determining whether a first external capture device (ECD) of a sending 3D call participant is in-use, if so, entering an ECD in-use mode, and if not entering an ECD not-in-use mode;
when in the ECD in-use mode, determining, based on determined movements of a second ECD of a recipient 3D call participant,
whether a first lock transition has occurred,
if so, displaying a hologram in a world-locked mode, and
if not, displaying the hologram in ECD-locked mode; and
when in the ECD not-in-use mode, determining whether a second lock transition, based on a user world-locked selection, has occurred,
if so, displaying an avatar in the world-locked mode, and
if not, displaying the avatar a body-locked mode.

18. The computing system of claim 17,
wherein determining whether the first ECD is in-use comprises determining that the first ECD is not in-use;
wherein determining whether the second lock transition has occurred comprises determining that the second lock transition has not occurred; and
wherein the avatar is for the sending 3D call participant and is displayed so as to appear consistently placed relative to the recipient 3D call participant by displaying the avatar at a consistent location in a display of the recipient 3D call participant.

19. The computing system of claim 17,
wherein the determining whether the first ECD is in-use comprises determining that the first ECD is in-use; and
wherein the process further comprises determining that at least a portion of the sending 3D call participant is blocked from view of the first ECD and, in response, causing display of an affordance to the sending 3D call participant by displaying a self-view of the sending 3D call participant with the blocked portion of the sending 3D call participant excluded.

20. The computing system of claim 17,
wherein determining whether the first ECD is in-use comprises determining that the first ECD is not in-use;
wherein determining whether the second lock transition has occurred comprises determining that the second lock transition has not occurred; and
wherein the avatar is for the sending 3D call participant and is displayed so as to appear consistently placed relative to the recipient 3D call participant by tracking a position of a part of the body of the recipient 3D call participant and repeatedly updating a displayed position of the avatar according to the tracked position.
